(19) United States
(12) Patent Application Publication
(10) Pub. No.: US 2023/0419938 A1
(43) Pub. Date: Dec. 28, 2023

(54) SOUND ABSORBING DEVICES AND ACOUSTIC RESONATORS DECORATED WITH FABRIC

(71) Applicant: Toyota Motor Engineering & Manufacturing North America, Inc., Plano, TX (US)

(72) Inventors: Taehwa Lee, Ann Arbor, MI (US); Yuyang Song, Ann Arbor, MI (US); Xiaopeng Li, Ann Arbor, MI (US); Ziqi Yu, Ann Arbor, MI (US)

(73) Assignees: Toyota Motor Engineering & Manufacturing North America, Inc., Plano, TX (US); Toyota Jidosha Kabushiki Kaisha, Toyota-shi, TX (US)

(21) Appl. No.: 17/851,422

(22) Filed: Jun. 28, 2022

(51) Int. Cl. G10K 11/168

(52) U.S. Cl. CPC G10K 11/168

(57) ABSTRACT

A sound absorbing device includes a chamber with an opening and at least one fabric layer extending across the opening. The at least one fabric layer extending across the opening is at least two fabric layers stacked relative to and in direct contact with each other, at least two fabric layers stacked relative to and spaced apart from each other by a predefined distance, at least one elastic fabric layer configured to vibrate independently from the chamber, or a three dimensional fabric layer. The at least two fabric layers stacked relative to and in direct contact with each other and the at least two fabric layers stacked relative to and spaced apart from each other by a predefined distance are configured to move relative to each other, and the at least one elastic fabric layer is configured to vibrate independently from the chamber.

### TECHNICAL FIELD

The present disclosure relates generally to sound absorbing devices, and particularly to sound absorbing devices that include acoustic resonators.

### BACKGROUND

Acoustic resonators, e.g., Helmholtz resonators and quarter-wave tubes, are used for acoustic absorption of specific frequency ranges. In addition, multiple acoustic resonators of different sizes can be used for more broadband acoustic absorption, however such structures can be cost and structurally prohibitive.

The present disclosure addresses issues related to the use of acoustic resonators for broadband acoustic absorption, and other issues related to acoustic absorption.

### SUMMARY

This section provides a general summary of the disclosure and is not a comprehensive disclosure of its full scope or all of its features.

In one form of the present disclosure, a sound absorbing device includes a chamber with an opening and at least one fabric layer extending across the opening. The at least one fabric layer extending across the opening is at least one of at least two fabric layers stacked relative to and in direct contact with each other, at least two fabric layers stacked relative to and spaced apart from each other by a predefined distance, at least one elastic fabric layer configured to vibrate independently from the chamber, and a three dimensional fabric layer with pores having a depth to diameter ratio of at least 100:1. The at least two fabric layers stacked relative to and in direct contact with each other and the at least two fabric layers stacked relative to and spaced apart from each other by a predefined distance are configured to move relative to each other. Also, at least one elastic fabric layer is configured to vibrate independently from the chamber.

In another form of the present disclosure, a sound absorbing device includes a chamber with an opening and at least two fabric layers stacked relative to and in direct contact with each other. Also, the at least two fabric layers are configured to move relative to each other such that a range of acoustic frequencies absorbed by the at least two fabric layers is adjustable.

In still another form of the present disclosure, a sound absorbing device includes a chamber with an opening and at least two fabric stacked relative to and spaced apart from each other. The at least two fabric layers are configured to move relative to each other such that a range of acoustic frequencies absorbed by the at least two fabric layers is adjustable.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 shows a sound absorbing device according to the teachings of the present disclosure;

FIG. 2A shows a sound absorbing device according to one form of the present disclosure;

FIG. 2B shows fabric in FIG. 2A with a predefined first average pore size according to the teachings of the present disclosure;

FIG. 2C shows fabric in FIG. 2A with a predefined second average pore size according to the teachings of the present disclosure;

FIG. 2D shows fabric in FIG. 2A with a predefined third average pore size according to the teachings of the present disclosure;

FIG. 2E shows fabric in FIG. 2A with a predefined fourth average pore size according to the teachings of the present disclosure;

FIG. 2F shows fabric in FIG. 2A with a predefined first range of sizes according to the teachings of the present disclosure;

FIG. 2G shows fabric in FIG. 2A with a predefined second range of sizes according to the teachings of the present disclosure;

FIG. 3A shows a sound absorbing device according to another form of the present disclosure with two layers of fabric spaced apart from each by a predefined distance d1;

FIG. 3B shows the sound absorbing device in FIG. 3A with the two layers of fabric spaced apart from each by a predefined distance d2;

FIG. 4 shows a sound absorbing device according to still another form of the present disclosure;

FIG. 5 shows a sound absorbing device according to still yet another form of the present disclosure;

FIG. 6 shows a plurality of Helmholtz resonators of the same size decorated with fabric according to the teachings of the present disclosure;

FIG. 7 shows two Helmholtz resonators of different size decorated with fabric according to the teachings of the present disclosure;

FIG. 8 shows a plurality of Helmholtz resonators decorated with fabric according to the teachings of the present disclosure;

FIG. 9A shows a substrate ‘S’ with a plurality of acoustic resonators covering an entire portion of a surface of the substrate S according to the teachings of the present disclosure;

FIG. 9B shows a substrate ‘S’ with a plurality of acoustic resonators covering only a portion of a surface of the substrate S according to the teachings of the present disclosure;

FIG. 10A is a plot of simulated reflectance/absorption as a function of an acoustic frequency for the acoustic resonator in FIG. 1 without fabric; and

FIG. 10B is a plot of simulated reflectance/absorption as a function of an acoustic frequency for the acoustic resonator in FIG. 1 with fabric.

### DETAILED DESCRIPTION

The present disclosure provides sound absorbing devices that include one or more acoustic resonators decorated with fabric. The acoustic resonators include a chamber with a cavity and an opening that provides fluid communication between an interior of the chamber and an exterior of the chamber. The chamber without the fabric is a lossy resonator for a predefined narrow range of acoustic frequencies and a lossless resonator for acoustic frequencies outside the predefined narrow range. However, sound absorbing devices according to the teachings of the present disclosure cover (decorate) the opening of the chamber with at least one fabric layer such that the acoustic resonator is a lossy acoustic resonator for acoustic frequencies outside the predefined narrow range. Accordingly, the sound absorbing devices use a simple design or structure to absorb a broad range of acoustic frequencies compared to acoustic resonators not decorated with fabricate according to the teachings of the present disclosure.

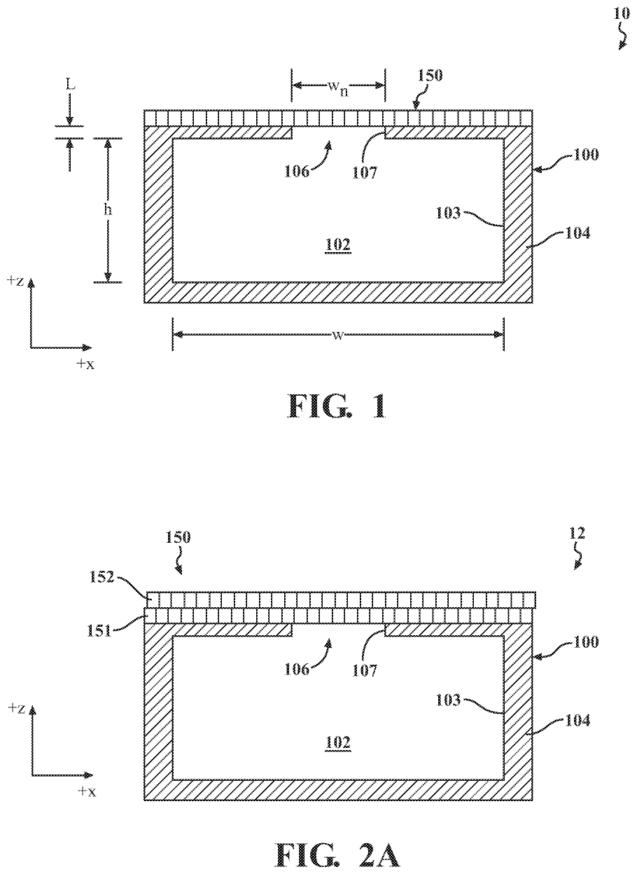

Referring to FIG. 1, a sound absorbing device 10 according to the teachings of the present disclosure includes an acoustic resonator 100 with a cavity 102 of gas (e.g., air) defined by an interior or inner surface 103 of at least one wall 104. The acoustic resonator 100 includes an opening 106 defined by at least one edge 107 of the at least one wall 104 and at least one fabric layer 150 extending across the opening as discussed in greater detail below. In some variations, the opening is a slit, i.e., an opening with a length greater than a width. In at least one variation, the acoustic resonator 100 is approximated or modeled as a Helmholtz resonator with the cavity 102 having a volume ‘V’ and the opening 106 having a thickness ‘T’ and an area ‘A’. In such variations, the acoustic resonator 100 has a single isolated resonant frequency ‘f’ defined as:

$$f = ( \frac{S}{2 π} ) \sqrt{\frac{A}{T V}} \qquad Eq . 1$$

where ‘S’ is the speed of sound. In addition, the acoustic resonator 100 can absorb a band of frequencies and reemit the frequencies with the opposite phase such that the reemitted frequencies interfere with the incoming sound waves via attenuation.

The at least one fabric layer 150 has a predefined thickness, average pore size, and porosity and can be made or formed from any type of fabric suitable for use to enhance acoustic loss. Non-limiting examples of fabric include silk, wool, linen cotton, rayon, nylon, polyesters, and combinations thereof, including woven fabrics such as plain weave fabric, twill weave fabric, and satin weave fabric. It should be understood that fabric generally absorbs acoustic waves by converting acoustic energy of acoustic waves into heat.

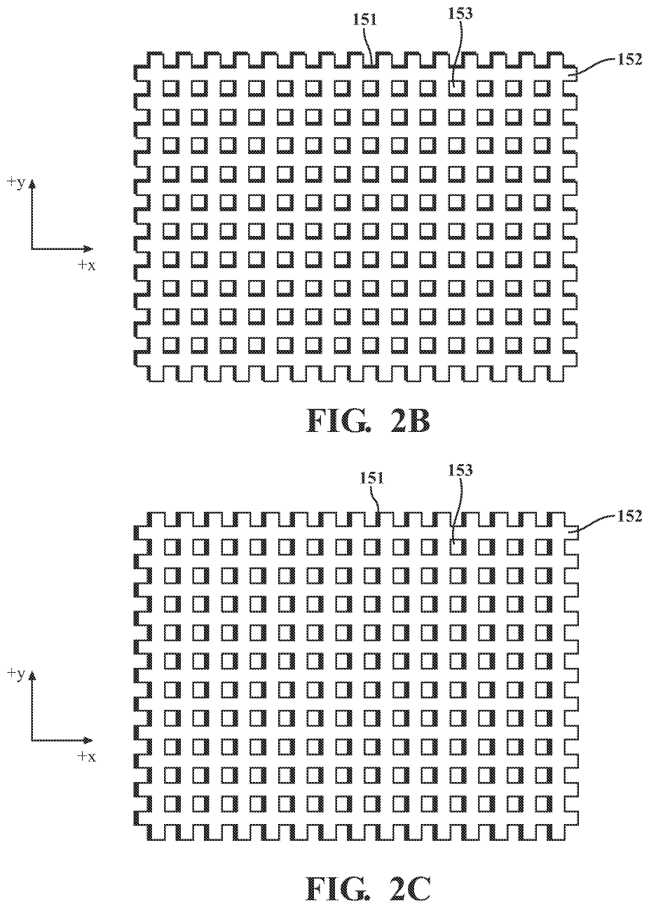

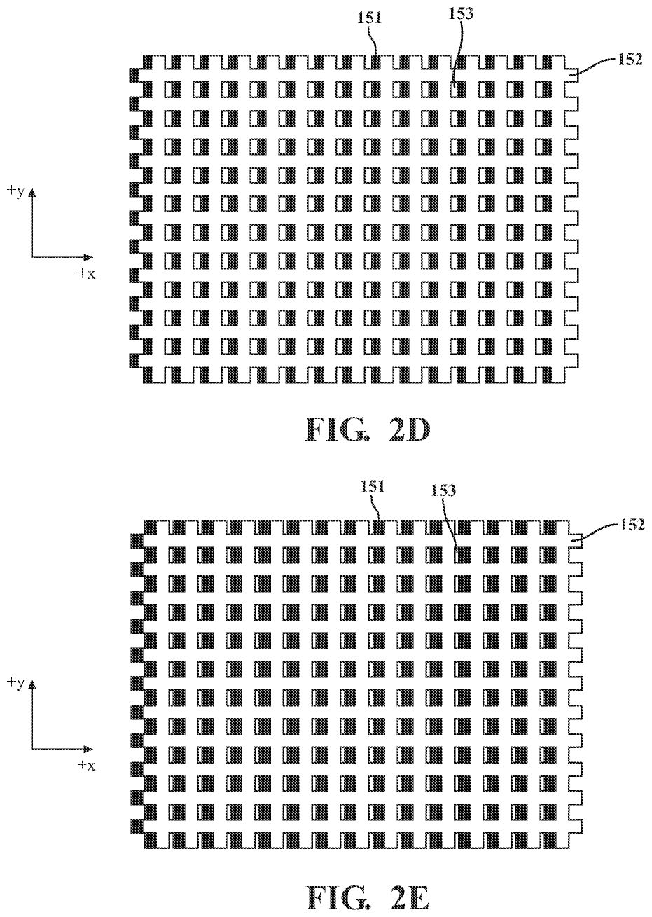

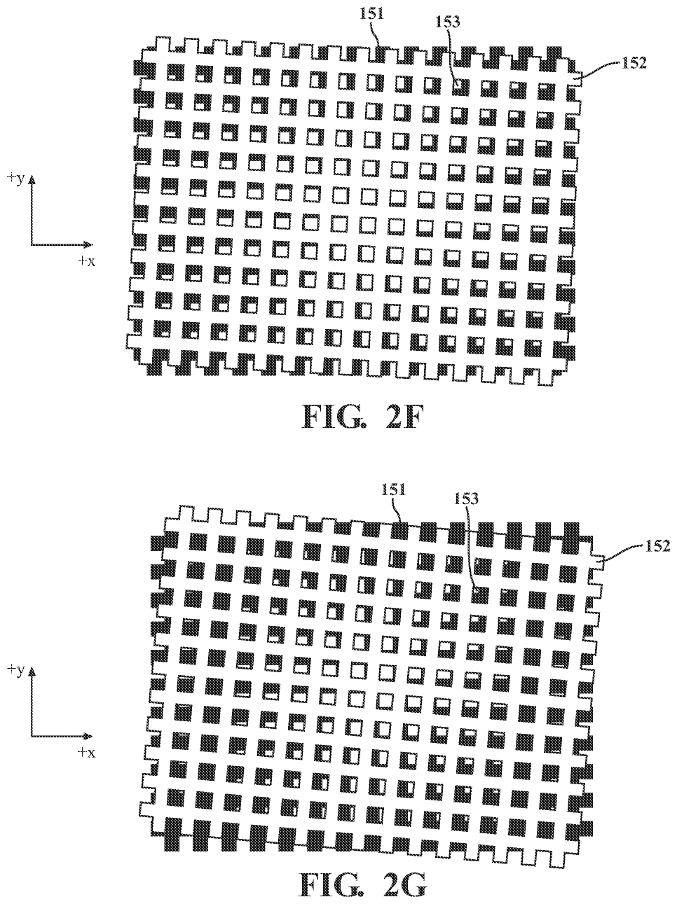

Referring now to FIGS. 2A-2G, a sound absorbing device 12 including the acoustic resonator 100 is shown in FIG. 2A and various positions of a pair of fabric layers decorating the opening 106 are shown in FIGS. 2B-2G. Particularly, the at least one fabric layer 150 includes a first fabric layer 151 and a second fabric layer 152 positioned or stack above (+z direction) the first fabric layer 151, and the first and second fabric layers 151, 152 (also referred to herein simply as “fabric layers 151, 152”) are configured to move relative to each other. In some variations, the fabric layers 151, 152 are in direct contact with each other.

Referring particularly to FIGS. 2B-2E, a top view of the fabric layers 151, 152 (i.e., viewing the fabric layers 151, 152 in the −z direction) is shown with the fabric layers 151, 152 displaced or moved relative to each other in the x-y plane such that the average size of pores 153 of the combined fabric layers 151, 152 changes (i.e., the average size of pores extending through the fabric layers 151, 152 changes). Particularly, FIG. 2B illustrates the fabric layers 151, 152 generally aligned with each other in the x- and y-directions such that the at least one fabric layer 150 has a predefined first average pore size and FIG. 2C illustrates the second fabric layer 152 moved or displaced in the +x direction relative to the first fabric layer 151 such that fibers of the second fabric layer interfere with the pores 153 of the first fabric layer 151, or vice versa, such that the at least one fabricate layer 150 has a predefined second average pores size that is less than the first predefined average pore size. In addition, FIG. 2D illustrates the second fabric layer 152 further moved or displaced in the +x direction relative to the first fabric layer 151 such that the at least one fabric layer 150 has a predefined third average pore size smaller than the predefined second average pore size, and FIG. 2E illustrates the second fabric layer 152 further moved or displaced in the +x direction relative to the first fabric layer 151 such that the at least one fabric layer 150 has a predefined fourth average pore size smaller than the predefined third average pore size.

And while FIGS. 2B-2E illustrate the fabric layers 151, 152 being moved relative to each other in a single direction, it should be understood that the fabric layers 151, 152 can be configured to move relative to each other in more than one direction. For example, FIG. 2F illustrates the second fabric layer 152 rotated about the z-axis relative to the first fabric layer 151 by a first angle and FIG. 2F illustrates the second fabric layer 152 rotated about the z-axis relative to the first fabric layer 151 by a second angle greater than the first angle. In addition, and in contrast to FIGS. 2B-2E illustrating a generally uniform pore size across the at least one fabric layer 150, FIGS. 2F-2G illustrate that rotation of the fabric layers 151, 152 relative to each other provides a range of pore sizes across the at least one fabric layer 150.

Accordingly, it should be understood from FIGS. 2A-2G that the fabric layers 151, 152 can be moved or displaced from each other in the x-y plane such that the pore size and pore size distribution are adjusted (changed) and such adjustment increases and/or decreases the range of acoustic frequencies absorbed by the fabric layers 151, 152 and the sound absorbing device 12. For example, and not being bound by theory, the pore size for “soft” fabrics does not change the resonance frequency of an acoustic resonator but does modify the acoustic dissipation and absorption frequency bandwidth. Also, a smaller pore size increases acoustic dissipation up to the optimum pore size. However, for “rigid” fabrics, the pore size affects both the resonance frequency and acoustic dissipation. The resonance frequency change can be estimated using Eq. 1 with a modified A given by Aₒ=σA where σ is the porosity.

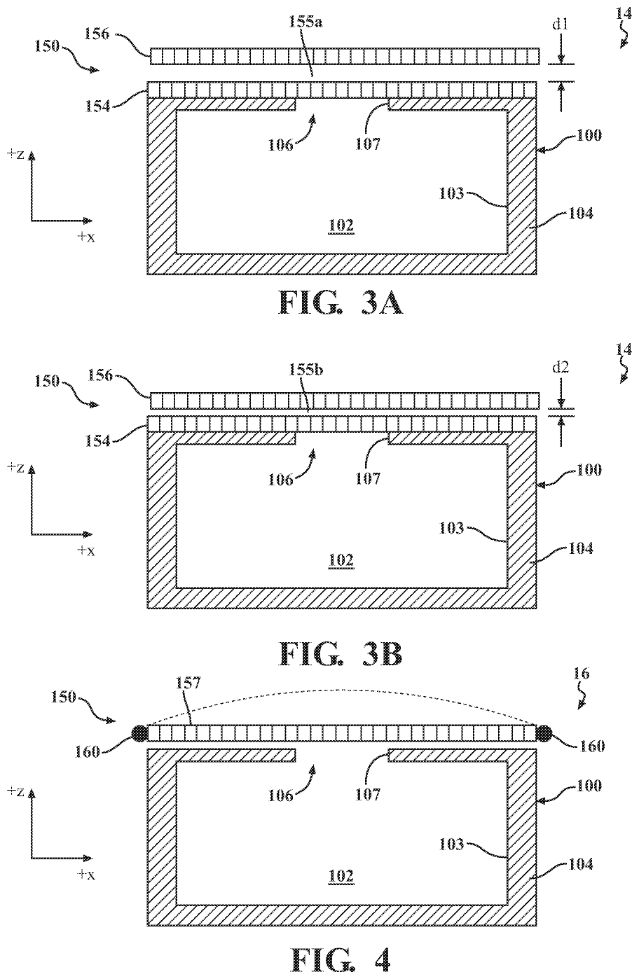

Referring now to FIGS. 3A-3B, a sound absorbing device 14 with the acoustic resonator 100 and at least two fabric layers spaced apart from each other by a predefined distance is shown. Particularly, the at least one fabric layer 150 includes a first fabric layer 154 and a second fabric layer 156 positioned or stack above (+z direction) the first fabric layer 154, and the first and second fabric layers 154, 156 (also referred to herein simply as “fabric layers 154, 156”) are configured to move relative to each other in the z-direction shown in the figures. For example, FIG. 3A illustrates the second fabric layer 156 spaced apart from the first fabric layer 154 by a distance ‘d1’ and FIG. 3B illustrates the second fabric layer 156 spaced apart from the first fabric layer 154 by a distance ‘d2’ that is less than the distance d1. Accordingly, a first volume 155a of gas (e.g., air) is present between the fabric layers 154, 156 separated by the distance d1 and a second volume 155b of gas that is less than the first volume 155a of gas is present between the fabric layers 154, 156 separated by the distance d2. In addition, moving the fabric layers 154, 156 in the z-direction relative each other by a predefined amount (distance) changes the volume of gas present between the fabric layers 154, 156 by a predefined amount. It should be understood that changing the volume between the fabric layers 154, 156 changes the range of acoustic frequencies absorbed by the fabric layers 154, 156. It should also be understood from FIGS. 3A-3B that the fabric layers 154, 156 can be moved or displaced from each other in the z-direction such that the volume of gas between the fabric layers 154, 156 changes in order to increase and/or decrease the range of acoustic frequencies absorbed by the fabric layers 154, 156 and the sound absorbing device 14. For example, and not being bound by theory, additional resonance peaks can be produced when d1 or d2 is chosen to be generally equal to πλ with π=0.1˜0.5 and the corresponding resonance frequency fₒ given by fₒ=c/λ.

Referring to FIG. 4, a sound absorbing device 16 including the acoustic resonator 100 with the at least one fabric layer 150 in the form of an elastic fabric layer 157 with a predefined modulus of elasticity is shown. In some variations, the elastic fabric layer 157 is rigidly attached to or anchored on opposite sides of the opening 106, e.g., attached to at least two anchors 160, such that the elastic fabric layer 157 is configured to vibrate between the at least two anchors 160 (nodes) as illustrated by the dotted line in FIG. 4. In at least one variation, the at least two anchors 160 are configured to move relative to each other in the x-y plane (e.g., in the x-direction) and/or to move relative to the acoustic resonator 100 in the z-direction). In variations where the at least two anchors 160 are configured to move relative to each other in the x-y plane, the at least two anchors either increase or decrease in distance between each other such that the elastic fabric layer 157 is either stretched more or stretched less, respectively, between the at least two anchors 160. In addition, the distance between the at least two anchors 160 (nodes) and the elasticity of the elastic fabric layer 157 changes such that the vibration characteristic(s) or property(ies) (e.g., resonant frequency) of the elastic fabric layer 157 is/are altered. Accordingly, the vibration characteristics or properties of the elastic fabric layer 157 are controlled and/or changed such that an increase and/or decrease in the range of acoustic frequencies absorbed by the elastic fabric layer 157 and the sound absorbing device 16 is provided.

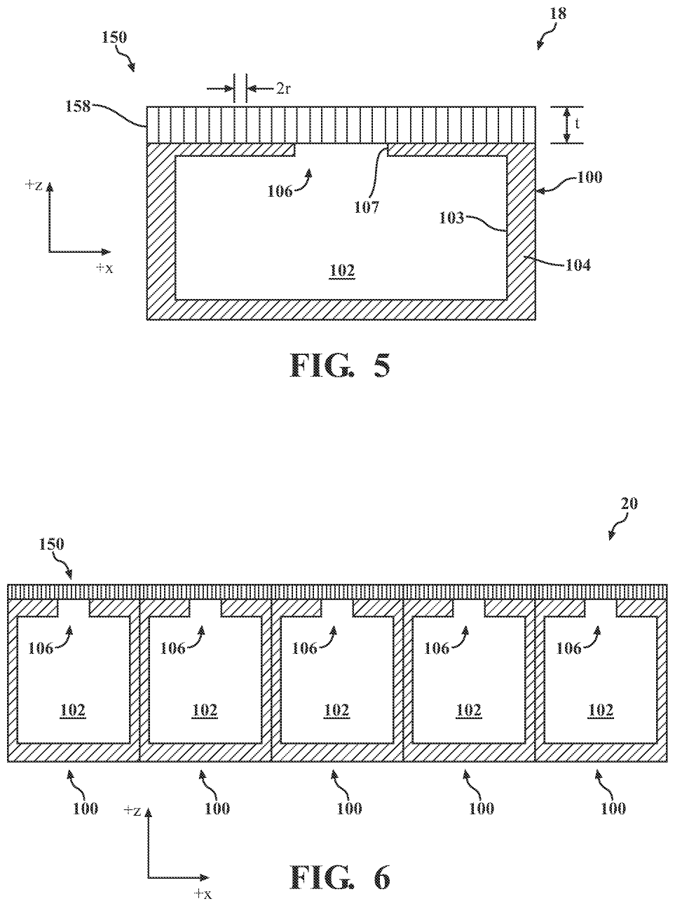

Referring to FIG. 5, a sound absorbing device 18 with the acoustic resonator 100 and the at least one fabric layer 150 in the form of a three dimensional (3D) textile fabric layer 158 extending across the opening 106 is shown. The 3D textile fabric layer 158 has a thickness ‘t’ and an average pore size ‘2r’. It should be understood that 3D textile fabric layers are manufactured with three planar geometry in contrast to two dimensional fabric layers (e.g., fabric layers 151, 152, 154, 156) that are manufactured on two planes. In addition, 3D textile fabric layers include a perpendicular weave (e.g., z-direction) in addition to a planar weave (e.g., x- and y-directions).

In some variations, a ratio of thickness t to average pore size 2r (t/2r) of the 3D textile fabric layer 158 is between about 10 and 100. And in at least one variation the sound absorbing device 18 is configured to stretch and/or compress the 3D textile fabric layer 158 in the x- and/or y-direction(s) such the thickness t and/or average pore size 2r, and thus the ratio t/2r changes. That is, the acoustic absorption characteristics or properties of the 3D textile fabric layer 158 can be changed from a first predefined value to a second predefine value. Accordingly, it should be understood from FIG. 5 that the acoustic absorption characteristics or properties of the 3D textile fabric layer 158 can be controlled and changed in order to increase and/or decrease the range of acoustic frequencies absorbed by the 3D textile fabric layer 158 and the sound absorbing device 18. For example, and not being bound by theory, the acoustic dissipation varies with the thickness of the of the 3D textile fabric layer 158 and with high dissipation increase bandwidth absorption. However, if the acoustic dissipation is too high, then peak absorption decreases.

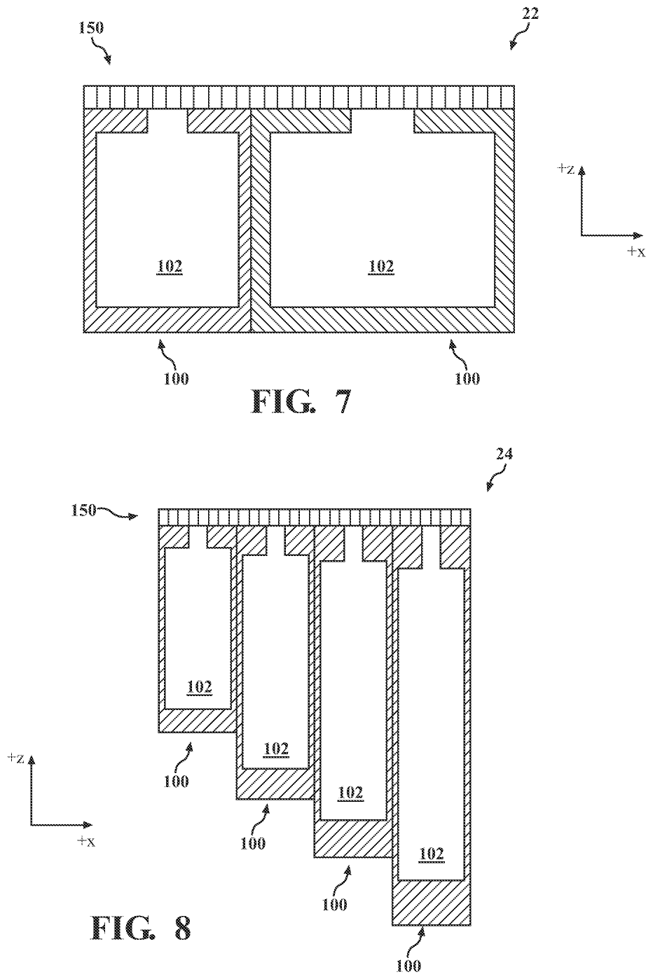

While FIGS. 1-5 illustrate sound absorbing devices with a single acoustic resonator 100, it should be understood that sound absorbing devices according to the teachings of the present disclosure can include more than one acoustic resonator. For example, and with reference to FIG. 6, a sound absorbing device 20 with a plurality of acoustic resonators 100 and at least one fabric layer 150 as discussed above is shown. In addition, FIG. 7 illustrates a first acoustic resonator 100 and a second resonator 110 with the at least one fabric layer 150 as discussed above, and the second acoustic resonator is different (e.g., different in size and/or material of construction) than the first acoustic resonator 100. And referring to FIG. 8, a sound absorbing device 24 with a plurality of different quarter wave tubes 120, 122, 124, 126 (e.g., different in size and/or material of construction) with the at least one fabric layer 150 as discussed above is shown.

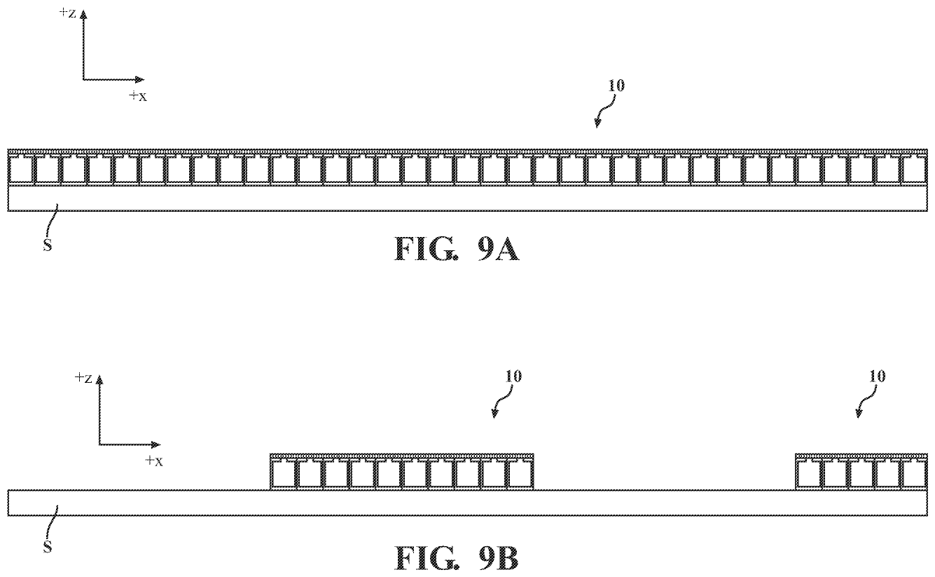

Referring to FIGS. 9A-9B a component or substrate ‘S’ with a plurality of sound absorbing devices 10 is shown (sound absorbing device 10 shown for example purposes only). In some variations, the plurality of sound absorbing devices 10 are disposed on or cover the entire substrate S as shown in FIG. 9A, while in other variations a plurality of sound absorbing devices 10 are disposed on or cover only a portion of the substrate S as shown in FIG. 9B. Non limiting examples of components and/or substrates that can have one or more sound absorbing devices disposed therein include interior motor vehicle panels, interior aircraft panels, interior wall panels, and others.

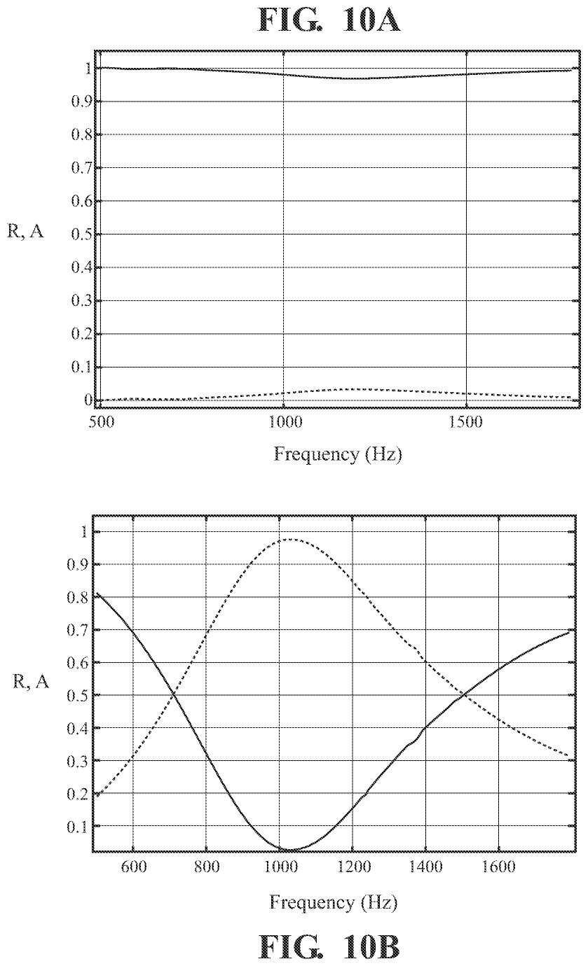

Referring now to FIGS. 10A-10B, one example of acoustic absorption by a sound absorbing device according to the teachings of the present disclosure is shown. Particularly, the acoustic resonator 100 illustrated in FIG. 1 with, and without, the at least one fabric layer 150 was tested for acoustic absorption for frequencies between 500 Hz and 1800 Hz.

Referring to FIG. 10 A, a plot of reflectance/absorption as a function of acoustic frequencies between 100 Hz and 1800 Hz for the acoustic resonator 100 without the at least one fabric layer 150 is shown. And referring to FIG. 10B, a plot of reflectance/absorption as a function of acoustic frequencies between 100 Hz and 1800 Hz for the acoustic resonator 100 with the at least one fabric layer 150 is shown. As observed from FIG. 1A the acoustic resonator 100 without the at least one fabric layer 150 generally reflected all of the acoustic frequencies between 500 Hz and 1800 Hz. In contrast, the acoustic resonator 100 with the at least one fabric layer 150 (FIG. 10B) absorbed about 90% of acoustic frequencies between about 925 Hz and about 1150 Hz, about 80% of acoustic frequencies between about 850 Hz and about 1225 Hz, about 70% of acoustic frequencies between about 800 Hz and about 1325 Hz, about 60% of acoustic frequencies between about 850 Hz and about 1400 Hz, and about 50% of acoustic frequencies between about 700 Hz and about 1500 Hz.

It should be understood from the teachings of the present disclosure that sound absorbing devices that include one or more acoustic resonators decorated with fabric are provided. The fabric can be at least one fabric layer that absorbs acoustic frequencies generally not absorbed by the one or acoustic resonators without the at least one fabric layer. That is, average pore size, the range of pore sizes, the distance and volume of gas between at least two fabric layers, and/or the elasticity and/or vibration properties of a fabric layer are adjustable such that an increased range of acoustic frequencies that are absorbed by the sound absorbing device is provided.

The preceding description is merely illustrative in nature and is in no way intended to limit the disclosure, its application, or uses. Work of the presently named inventors, to the extent it may be described in the background section, as well as aspects of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple variations or forms having stated features is not intended to exclude other variations or forms having additional features, or other variations or forms incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one variation, or various variations means that a particular feature, structure, or characteristic described in connection with a form or variation or particular system is included in at least one variation or form. The appearances of the phrase “in one variation” (or variations thereof) are not necessarily referring to the same variation or form. It should be also understood that the various method steps discussed herein do not have to be carried out in the same order as depicted, and not each method step is required in each variation or form.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A sound absorbing device comprising:
a chamber with an opening; and
at least one fabric layer extending across the opening, wherein the at least one fabric layer extending across the opening comprises at least one of:
at least two fabric layers stacked relative to and in direct contact with each other, the at least two fabric layers stacked relative to and in direct contact with each other configured to move relative to each other;
at least two fabric layers stacked relative to and spaced apart from each other by a predefined distance;
at least one elastic fabric layer configured to vibrate independently from the chamber; and
a three dimensional fabric layer with pores having a depth to diameter ratio of at least 100:1.

2. The sound absorbing device according to claim 1, wherein the opening is a slit.

3. The sound absorbing device according to claim 1, wherein the chamber with the opening comprises a plurality of chambers with a plurality of openings and the at least one fabric layer extending across the opening comprises at least one fabric layer extending across the plurality of openings.

4. The sound absorbing device according to claim 1, wherein the at least one fabric layer extending across the opening is the at least two fabric layers stacked relative to and in direct contact with each other.

5. The sound absorbing device according to claim 4, wherein the at least two fabric layers stacked relative to and in direct contact with each other are configured to move in at least one direction relative to each other such that an average pore size for a plurality of pores extending through the at least two fabric layers is adjustable.

6. The sound absorbing device according to claim 4, wherein the at least two fabric layers stacked relative to and in direct contact with each other are configured to rotate relative to each other such that a range of pore sizes for a plurality of pores extending through the at least two fabric layers is adjustable.

7. The sound absorbing device according to claim 1, wherein the at least one fabric layer extending across the opening is two fabric layers stacked relative to and spaced apart from each other by the predefined distance.

8. The sound absorbing device according to claim 7, wherein the predefined distance defines a volume between the two fabric layers stacked relative to and spaced apart from each other.

9. The sound absorbing device according to claim 7, wherein the predefined distance is adjustable such that a defined volume between the two fabric layers stacked relative to and spaced apart from each other changes.

10. The sound absorbing device according to claim 1, wherein the at least one fabric layer extending across the opening is the at least one elastic fabric layer configured to vibrate independently from the chamber.

11. The sound absorbing device according to claim 10, wherein the at least one elastic fabric layer is rigidly attached on opposite sides of the opening.

12. The sound absorbing device according to claim 11, wherein the at least one elastic fabric layer is rigidly attached to at least two anchors positioned on the opposite sides of the opening.

13. The sound absorbing device according to claim 12, wherein a distance between the at least two anchors is adjustable such that a resonant frequency of the at least one elastic fabric layer is adjustable.

14. The sound absorbing device according to claim 1, wherein the at least one fabric layer extending across the opening is the three dimensional fabric layer with pores.

15. The sound absorbing device according to claim 14, wherein the three dimensional fabric layer with pores is rigidly attached to two anchors positioned on opposite sides of the opening.

16. The sound absorbing device according to claim 15, wherein a distance between the two anchors is adjustable such that the depth to diameter ratio of the pores of the three dimensional fabric layer is adjustable.

17. A sound absorbing device comprising:
a chamber with an opening; and
at least two fabric layers stacked relative to and in direct contact with each other, the at least two fabric layers configured to move relative to each other such that a range of acoustic frequencies absorbed by the at least two fabric layers is adjustable.

18. The sound absorbing device according to claim 17, wherein an average pore size for a plurality of pores extending through the at least two fabric layers changes when the at least two fabric layers move relative to each other.

19. A sound absorbing device comprising:
a chamber with an opening; and
at least two fabric layers stacked relative to and spaced apart from each other, the at least two fabric layers configured to move relative to each other such that a range of acoustic frequencies absorbed by the at least two fabric layers is adjustable.

20. The sound absorbing device according to claim 19, wherein a volume of gas between the at least two fabric layers changes when the at least two fabric layers move relative to each other.
